(19) United States
(12) Patent Application Publication
(10) Pub. No.: US 2009/0144069 A1
(43) Pub. Date: Jun. 4, 2009

(54) System and method for providing personalized service

(75) Inventors: Dong-Oh Kang, Daejeon (KR); Young Sung Kim, Daejeon (KR); Ki Ryong Ha, Daejeon (KR); Jeun Woo Lee, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/155,460

(22) Filed: Jun. 4, 2008

(30) Foreign Application Priority Data
Nov. 29, 2007 (KR) 10-2007-0123079

(51) Int. Cl. G06Q 99/00

(52) U.S. Cl. 705/1

(57) ABSTRACT

Disclosed herein is a system for providing personalized service. The system for providing personalized service includes one or more bio-signal measurement sensors and a service terminal. The bio-signal measurement sensors measure a user's bio-signals and output the measured bio-signals over a communication network. The service terminal establishes a service provision plan based on the bio-signals, measured by the bio-signal measurement sensors, and information about characteristics of use depending on use of service by the user, and providing service.

### CROSS-REFERENCE(S) TO RELATED APPLICATIONS

The present invention claims priority of Korean Patent Application No. 10-2007-0123079, filed on Nov. 29, 2007, which is incorporated herein by reference.

### FIELD OF THE INVENTION

The present invention relates to a system and method for providing personalized service more suitable for a user based on the user's bio-signals and information about the characteristics of use of the service by the user.

### BACKGROUND OF THE INVENTION

In general, a personalized service is a service that is provided in such a way as to measure the characteristics of use of service by a user in order to understand the user's intention and to extract and classify the user's characteristics based on the measured aspects.

Since prior art technologies related to personalized service do not use feedback from users or use feedback directly input by users, it is difficult for the users to use the technologies and it is difficult to understand users' varying tendencies. Accordingly, the prior art technologies are problematic in that they can not provide appropriate personalized service.

### SUMMARY OF THE INVENTION

It is, therefore, an object of the present invention to provide personalized service more suitable for a user in such a way as to measure the amount of stress of the user by means of wearable bio-signal sensors, use the measured amount of stress as feedback in the provision of the service, and measure the user's habits and characteristics of use of the service.

Another object of the present invention is to provide service to a user at appropriate times in such a way as to use the amount of stress measured by means of the wearable bio-signal sensors, and the times, periods and frequency of the use of service collected through a user service terminal, and to consider the computing environment, such as the memory and CPU of the user service terminal.

In accordance with a first aspect of the present invention, there is provided a system for providing a personalized service including: one or more bio-signal measurement sensors for measuring a user's bio-signal and outputting the measured bio-signal over a communication network; and a service terminal for establishing a service provision plan based on the bio-signal measured by the bio-signal measurement sensors and information about characteristics of use which depends on use of each service by the user to provide a service.

In accordance with a second aspect of the present invention, there is provided a method of providing personalized service including: whenever each service is provided through a service terminal, creating a preference function for each service based on a user's bio-signal measured by bio-signal measurement sensors and information about characteristics of use of each service, and storing the created preference function in memory; establishing a service provision plan based on preference functions for respective services stored in the memory; and providing service through the service terminal based on the service provision plan.

According to the present invention, not only a user's characteristics of use of service but also the user's bio-signals attributable to the use of service, measured by means of bio-signal sensors, are automatically provided and a service is provided based on the information about the characteristics of use of the service and the bio-signals, so that a personalized service can be provided to users.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram showing a system for providing a personalized service using a user's bio-signals according to a preferred embodiment of the present invention;

FIG. 2 is a block diagram showing the internal construction of a service terminal according to a preferred embodiment of the present invention;

FIG. 3 is a diagram showing a preference function according to the present invention;

FIG. 4 is a flow chart showing a process of providing a service based on a user's bio-signals according to a preferred embodiment of the present invention;

FIG. 5 is a flow chart showing a process of providing a service based on preference functions for respective services according to a -preferred embodiment of the present invention; and

FIG. 6 is a flow chart showing a process of processing two or more options when the options exist in service at the time of providing the service according to a preferred embodiment of the present invention.

### DETAILED DESCRIPTION OF THE PREFERRED EMBODIMENTS

Preferred embodiments of the present invention will be described in detail below with reference to the accompanying drawings. Meanwhile, in the following description of the present invention, detailed descriptions of well-known functions and/or constructions will be omitted if it is determined that they may make the gist of the present invention obscure.

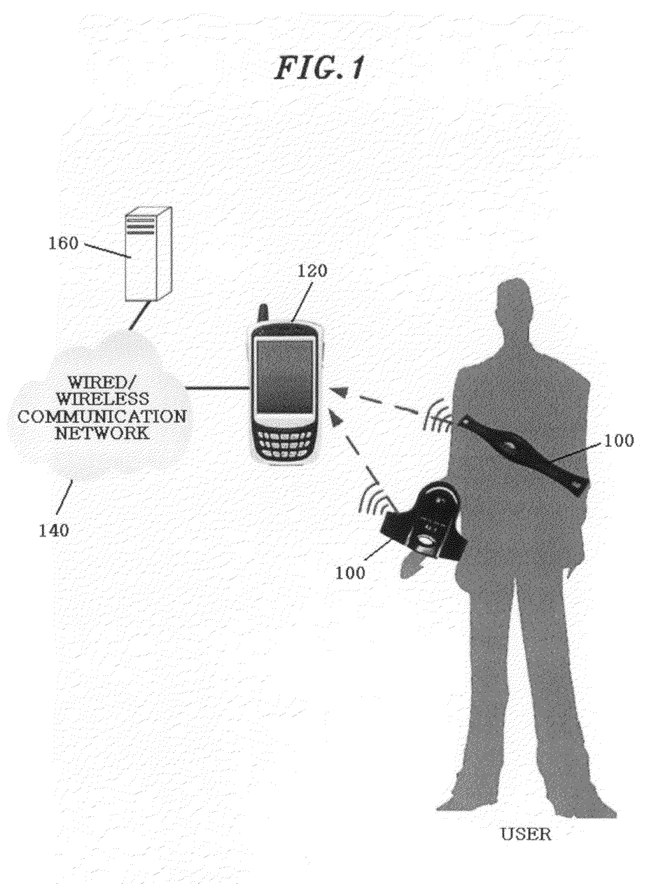

FIG. 1 is a diagram showing a system for providing a personalized service using a user's bio-signals according to a preferred embodiment of the present invention. The system includes wearable bio-signal sensors 100, a service terminal 120, a wired/wireless communication network 140, and a service provision server 160. Here, the wearable bio-signal sensors 100 and the service terminal 120 transmit measured information through a Wireless Personal Area Network (hereinafter referred to as ‘WPAN’), such as a ZigBee or Bluetooth network, or a Wireless Body Area Network (hereinafter referred to as ‘WBAN’).

The wearable bio-signal sensors 100 measure the user's bio-signals, such as an Electrocardiogram (ECG) and a Photoplethysmogram (PPG), and provide the measured bio-signals to the user's service terminal 120 through a WPAN or WBAN wireless module.

The service terminal 120 collects information about the user's habits of use of the service and the characteristics of use of the service by the user, such as a user's times, periods and frequency of use of the service, receives the user's bio-signals from the wearable bio-signal sensors 100 through a WPAN or WBAN, calculates the amount of stress based on the received bio-signals, and controls a service provision method based on the calculated amount of stress.

The service terminal 120 accesses the service provision server 160 over the wired/wireless communication network 140, such as a wired/wireless Local Area Network (LAN) or a Code Division Multiple Access (CDMA) network, and receives service codes for execution of the service from the service provision server 160.

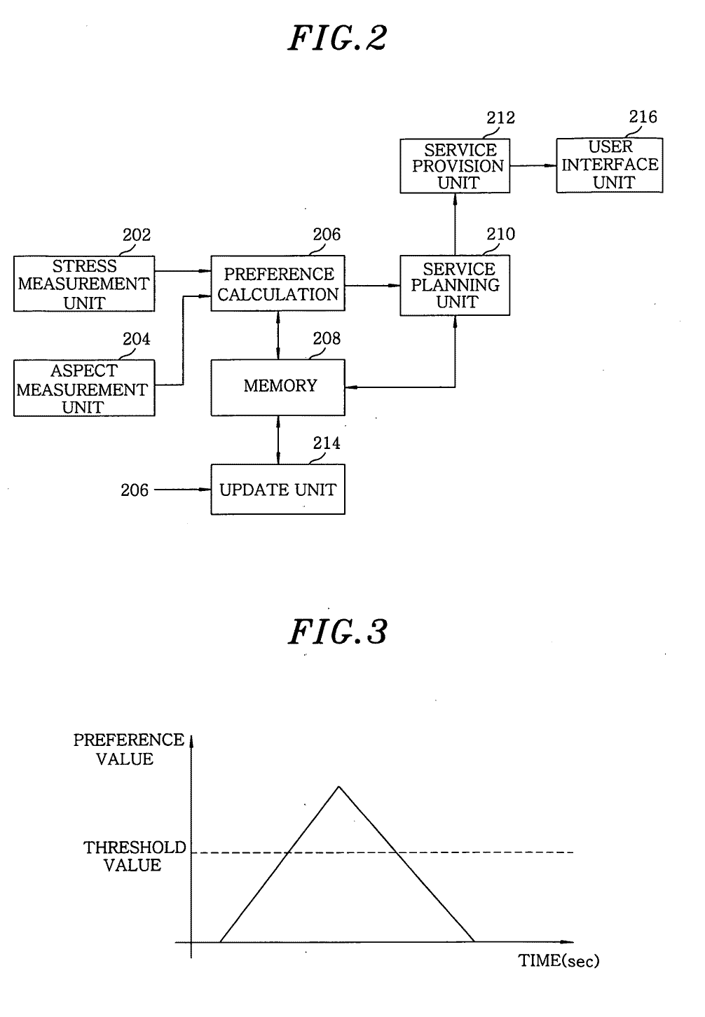

As shown in FIG. 2, the service terminal 120 according to the present invention includes a stress measurement unit 202, an aspect measurement unit 204, a preference calculation unit 206, a memory 208, a service planning unit 210, a service provision unit 212, an update unit 214, and a user interface unit 216.

The stress measurement unit 202 measures the amount of stress based on a user's bio-signals that are provided by the bio-signal sensors 100 when the user is provided with a specific service or an option of the service through the service terminal 120, and provides the measured amount of stress to the preference calculation unit 206. Here, the amount of stress is taken as the degree of negative preference of the user.

The aspect measurement unit 204 measures information about the characteristics of use of a service whenever each service is provided to the user, and provides the measured information to the preference calculation unit 206. Here, examples of the information about the characteristics of use may be the times, periods and frequency of use of the service.

Meanwhile, when at least two options exist in a service provided to a user, the aspect measurement unit 204 measures information about the characteristics of use for each option respectively, and provides the measured information to the preference calculation unit 206.

The preference calculation unit 206 creates a preference function for each service provided to a user based on the amount of stress and the information about the characteristics of use, and stores the created preference function in the memory 208. The preference function is a time function, and is configured such that preference values are plotted against time, as shown in FIG. 3.

Meanwhile, the preference calculation unit 206 receives the amount of stress and the information about the characteristics of use for each option of the service from the stress measurement unit 202 and the aspect measurement unit 204, calculates each preference value for each option based on the amount of stress and the information about the characteristics of use for each option, and stores the calculated preference value in the memory 208.

The service planning unit 210 makes a service provision plan based on preference functions for respective services stored in the memory 208. Here, the service provision plan is the setting of services to be provided in specific periods. The service planning unit 210 searches respective periods where the preference functions of respective services have preference values higher than a threshold value, and establishes a service provision plan for the provision of services in respective periods through the comparison of found periods.

The service provision unit 212 provides services based on the service provision plan of the service planning unit 210. The service provision unit 212 provides services found through internal searching in the service terminal 120, or accesses the service provision server 160 over the wired/wireless communication network 140, downloads services from the service provision server 160, and provides the downloaded services to a user.

The service provision unit 212 executes service codes, found through the internal searching or downloaded over a network, in order to provide the user with the services.

In the case where the service provision unit 212 provides services or options of services based on a service provision plan as described above, the update unit 214 can recalculate preference functions for the provided services or preference values for the provided options based on the amounts of stress and information about the characteristics of use for the provided services or the provided options, and updates the memory 208.

Meanwhile, when preference values for all of the options are lower than a threshold value, the service provision unit 212 may arbitrarily select and provide any one of the options, or may select an option having the highest preference value from among the options and then provide the option.

When the service is provided, the user interface unit 216 provides a user with a message announcing the provision of the service, such as a specific alarm, through the speaker (not shown) of the service terminal 120, or displays an icon for the provision of the service on the desktop of the service terminal 120 in order to increase the user's convenience.

The service provision server 160 is connected to the service terminal 120 over the wired/wireless communication network 140 and provides service codes to the service terminal 120 at the request of the service terminal 120, and the service terminal 120 provides a service to the user through the execution of the service codes.

Meanwhile, although, in the present invention, the preference function and the preference value have been described as being calculated or updated based on the amount of stress and the information about the characteristics of use, the preference function and the preference value may be calculated or updated in further consideration of the states of the service terminal 120, such as the capacity of the memory and state of the CPU of the service terminal 120, and the threshold value may also be controlled.

Furthermore, in the case in which the state of the service terminal 120 is invalid, service preparation times, that is, service provision times, can be controlled by adjusting the threshold value or the width of the preference function, so that the service terminal 120 can be stabilized or a service can be supplied efficiently.

Respective elements of the service terminal 120 of the present invention can be implemented in various forms, such as an Open Service Gateway initiative (hereinafter referred to as ‘OSGi’) form or a Java application.

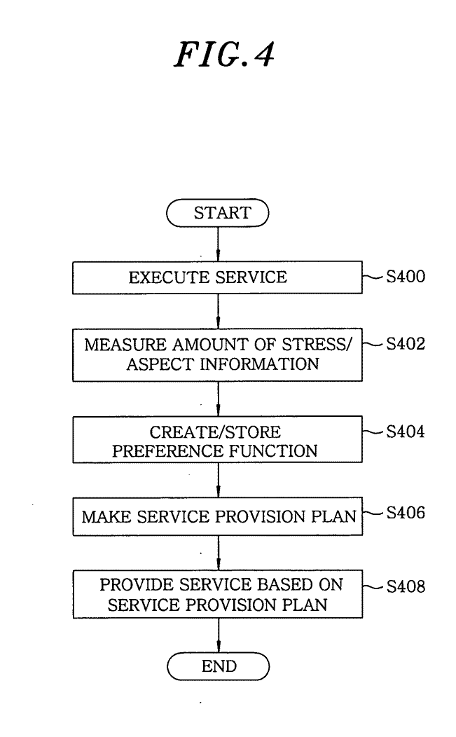

The process, in which the service providing system having the above-described construction provides a service based on a user's bio-signals, is described with reference to FIG. 4.

FIG. 4 is a flow chart showing a process of providing a service based on a user's bio-signals according to a preferred embodiment of the present invention.

Referring to FIG. 4, whenever each service is provided to a user through the service terminal 120 (step S400), the stress measurement unit 202 of the service terminal 120 receives bio-signals from the bio-signal sensors 100 worn by the user and measures the amount of stress based on the bio-signals, and the aspect measurement unit 204 measures information about the characteristics of use of each service (step S402).

Thereafter, the preference calculation unit 206 creates a preference function for each service based on the information about the characteristics of use and the amount of stress measured for each service, and stores the created preference function for each service in the memory 208 (step S404).

The service planning unit 210 makes a service provision plan based on preference functions for respective services stored in the memory 208 (step S406). That is, the service planning unit 210 extracts time information, having preference values higher than a threshold value, from the preference functions for respective services and makes a service provision plan for providing services in respective periods based on the extracted time information. For example, in the case where service A has a preference value higher than a threshold value between 10 o'clock am and 11 o'clock am in the preference function of the service A and service B has a preference value higher than the threshold value between 12 o'clock am and 1 o'clock pm in the preference function of the service B, the service planning unit 210 makes a service provision plan in which the service A is provided between 10 o'clock am and 11 o'clock am and the service B is provided between 12 o'clock am and 1 o'clock pm.

Based on the service provision plan, which is made by the service planning unit 210 as described above, the service provision unit 212 provides a service found through the internal searching in the service terminal 120, or accesses the service provision server 160 through the wired/wireless communication network 140, downloads a relevant service and provides the service (step S408).

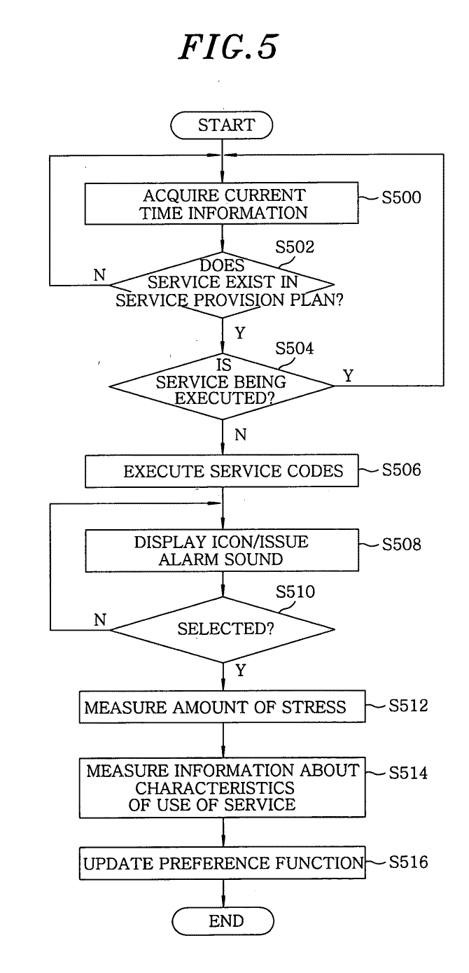

A process of providing a service based on preference functions for respective services in the service provision process is described below with reference to FIG. 5.

FIG. 5 is a flow chart showing a process of providing a service based on preference functions for respective services according to a preferred embodiment of the present invention.

Referring to FIG. 5, first, the service provision unit 212 of the service terminal 120 acquires current time information (step S500), and determines whether a service corresponding to the current time exists by searching the established service provision plan (step S502).

If, as a result of the determination at step S502, a service corresponding to the current time exists, the service provision unit 212 determines whether the service set in the service provision plan is being executed (step S504).

If, as a result of the determination at step S504, the service is not being executed, the service provision unit 212 executes service codes, which are found through internal searching in the service terminal 120 or which are downloaded from the service provision server 160 through the wired/wireless communication network 140 (step S506) According to step S506, the user interface unit 218 of the service terminal 120 displays an icon for the provision of the service on its display window (not shown) and also transmits a specific alarm message, such as an alarm, through the speaker (not shown) of the service terminal 120 (step S508).

Here, the alarm can be selectively output according to the user's setting. That is, if the user turns on an alarm setting function through the user interface unit 218 of the service terminal 120, an alarm is issued through the speaker. In contrast, if the user does not turn on the alarm setting function, the alarm is not issued through the speaker.

Thereafter, the service terminal 120 determines whether the user selects the icon displayed on the display window in order to receive the service (step S510).

If, as a result of the determination at step S510, the user selects the icon, that is, the service is executed, the stress measurement unit 202 receives the user's bio-signals from the bio-signal sensors 100 worn by the user and measures the amount of stress based on the bio-signals (step S512). Furthermore, the aspect measurement unit 204 measures information about the characteristics of use of the service (step S514). The information about the characteristics of use and the amount of stress, measured as described above, are input to the preference calculation unit 206.

The preference calculation unit 206 calculates a preference value based on the amount of stress of the service currently being executed and the information about the characteristics of use of the service currently being executed (step S516), and provides the calculated preference value to the update unit 214. The update unit 214 updates the preference function of the service currently being executed based on the received preference value (step S518).

Meanwhile, if, as a result of the determination at steps S502 or S504, the service corresponding to the current time does not exist in the service provision plan or the service is being executed, the service terminal 120 returns to step S500, in which it acquires current time information after the elapse of a predetermined time period.

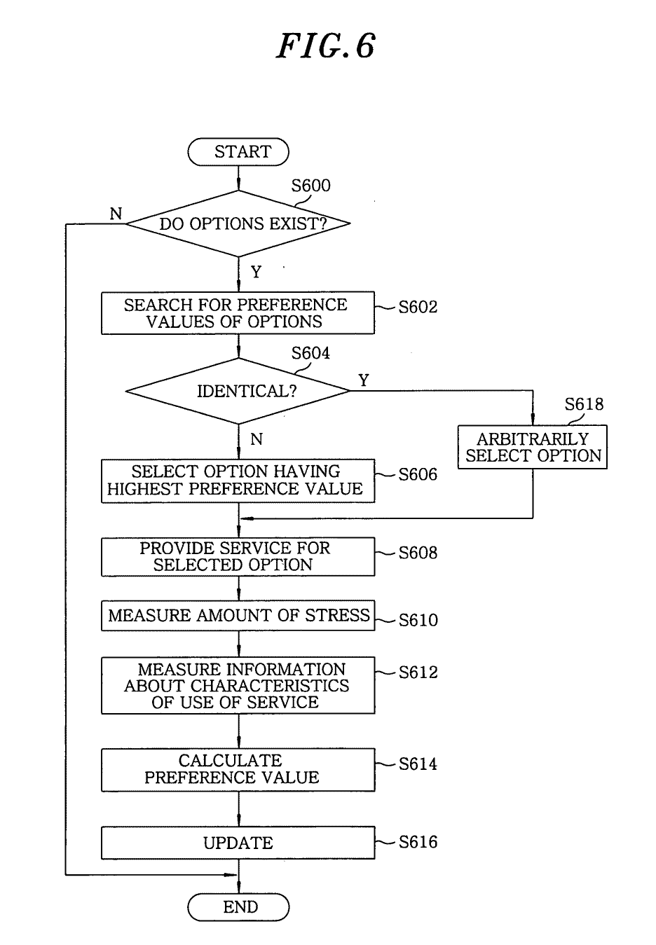

A process of processing detailed options when the detailed options exist in a service at the time of providing the service as described above is described with reference to FIG. 6.

FIG. 6 is a flow chart showing a process of processing two or more options when the options exist in a service at the time of providing the service according to a preferred embodiment of the present invention.

Referring to FIG. 6, first, before providing a service, the service terminal 120 determines whether options exist in the service (step S600).

If, as a result of the determination at step S600, two or more options exist in the service, the service provision unit 212 searches the memory 208 for preference values of the options (step S602) and determines whether the preference values of the options are identical (step S604).

If, as a result of the determination at step S604, the preference values of the options are not identical, the service provision unit 212 selects an option having the highest preference value (step S606) and provides a service for the selected option (step S608).

Meanwhile, after the service according to the option in the service is provided, the stress measurement unit 202 receives the user's bio-signals from the bio-signal sensors 100 worn by the user and measures the amount of stress based on the bio-signals (step S610). Furthermore, the aspect measurement unit 204 measures information about the characteristics of use of the option in the service (step S612). The information about the characteristics of use and the amount of stress, measured as described above, are input into the preference calculation unit 206.

The preference calculation unit 206 calculates a preference value based on the amount of stress for the option currently being executed and information about the characteristics of use of the service currently being executed (step S614) and provides the calculated preference value to the update unit 214. The update unit 214 updates the preference value of the option currently being executed with the received preference value (step S616).

Meanwhile, if, as a result of the determination at step S604, the preference values of the options are identical, the service provision unit 212 arbitrarily selects any one from among the options (step S618), and goes to the step S608, in which the service provision unit 212 performs the subsequent steps.

Meanwhile, although a relevant illustration is omitted in FIG. 6, when a user inputs evaluation information about a selected option, such as “good”, “bad” or “ordinary,” through the user interface unit 216, the update unit 214 calculates a preference value for the selected option based on the evaluation information and updates the preference value of the option, stored in the memory 208, with the calculated preference value.

As described above, according to the present invention, a service can be provided employing not only information about the characteristics of use of the service, such as a user's times, periods and frequency of use of the service, but also the amount of stress, that is, the user's unconscious feedback, measured by means of the wearable bio-signal sensors, rather than conscious feedback. Accordingly, a personalized service can be provided to each user.

Furthermore, the present invention can adjust the service provision time and method by adjusting a threshold value, depending on the state of the service terminal 120.

Although the embodiments of the present invention have been described so far, it will be apparent to those skilled in the art that the technologies of the present invention can be modified easily. Such modified embodiments should be considered as being included in the technical spirit described in the claims of the present invention.

What is claimed is:

1. A system for providing a personalized service, comprising:
one or more bio-signal measurement sensors for measuring a user's bio-signals and outputting the measured bio-signals over a communication network; and
a service terminal for establishing a service provision plan based on the bio-signals, measured by the bio-signal measurement sensors and information about characteristics of use that depends on use of each service by the user to provide a service.

2. The system of claim 1, wherein the communication network includes a Wireless Personal Area Network (WPAN) and a Wireless Body Area Network (WBAN).

3. The system of claim 1, wherein the service terminal includes:
a stress measurement unit for calculating an amount of stress based on the bio-signals measured by the bio-signal measurement sensors whenever each service is provided to the user through the service terminal;
an aspect measurement unit for measuring the information about characteristics of use of each service provided to the user; and
a preference calculation unit for creating a preference function or a preference value for each service based on the measured information about characteristics of use and the calculated amount of stress and storing the created preference function or preference value in a memory.

4. The system of claim 3, wherein the service terminal further includes:
a service planning unit for establishing the service provision plan based on the preference function for each service stored in the memory.

5. The system of claim 4, wherein the service planning unit establishes the service provision plan based on the preference function by extracting time information about where the preference value for each service is higher than a threshold value.

6. The system of claim 4, wherein the service terminal further includes:
a service provision unit for, in order to provide a service based on the service provision plan, downloading the service from a service provision server over an external network or extracting the service through internal searching in the service terminal.

7. The system of claim 6, wherein the service terminal further includes:
an update unit for calculating a preference value for the corresponding service through the preference calculation unit when the corresponding service is provided by the service provision unit, and updating the preference value of the corresponding service stored in the memory.

8. The system of claim 3, wherein, if two or more options exist within the service when the service is provided to the user, the preference calculation unit receives an amount of stress and information about the characteristics of use for each option from the stress measurement unit and the aspect measurement unit; calculates a preference value for each option based on the received amount of stress and information about the characteristics of use for each option, and; stores the calculated preference value for each option in the memory.

9. The system of claim 8, wherein the service terminal further includes:
a service provision unit for, at the time of providing the user with a service including two or more options, selecting any one from among the options based on the preference values for respective options stored in the memory and providing the selected option.

10. The system of claim 9, wherein the service provision unit arbitrarily selects any one from among the options when the preference values for respective options are less than a threshold value, and provides the selected option.

11. The system of claim 9, wherein the service terminal further includes:
an update unit for calculating a preference value for the selected option through the preference calculation unit and updating the memory.

12. The system of claim 1, wherein the bio-signal measurement sensors includes an Electrocardiogram (ECG) sensor, a Photoplethysmogram (PPG) measurement sensor, or ECG and PPG measurement sensors.

13. The system of claim 5, wherein the threshold value varies with a CPU load or memory state of the service terminal.

14. A method of providing personalized service, comprising:
whenever each service is provided through a service terminal, creating a preference function for each service based on a user's bio-signals measured by bio-signal measurement sensors and information about characteristics of use of each service, and storing the created preference function in memory;
establishing a service provision plan based on preference functions for respective services stored in the memory; and
providing service through the service terminal based on the service provision plan.

15. The method of claim 14, wherein the storing the preference function in the memory includes:
measuring an amount of stress attributable to the use of each service based on the bio-signals; and
creating the preference function for each service based on the amount of stress and the information about characteristics of use of each service, and storing the created preference function in the memory.

16. The method of claim 14, further comprising, as each service is provided based on the service provision plan, updating the preference function by calculating the
preference value for the provided service based on the user's bio-signals attributable to provision of the service and the information about characteristics of use of the provided service.

17. The method of claim 14, wherein the providing the service through the service terminal includes:
accessing a service provision server over an external network and downloading the service from the service provision unit; or finding the service through internal searching in the service terminal.

18. The method of claim 14, wherein the providing the service through the service terminal includes:
providing the service terminal with a user interface corresponding to the service that will be provided to the user;
determining whether an alarm function has been set for the service that will be provided;
if, as a result of the determination, the alarm function has been set for the service, transmitting a specific alarm message to the service terminal; and
providing the service according to selection of the service through the user interface.

19. The method of claim 14, wherein the establishing the service provision plan includes:
extracting time information about where the preference value is higher than a threshold value, for respective services based on the preference functions stored in the memory; and
establishing the service provision plan for respective services based on the extracted time information.

20. The method of claim 19, further comprising:
if services corresponding to the extracted time information are two or more in number, establishing the service provision plan such that a service having a highest preference value in the extracted time information can be provided.

21. The method of claim 14, wherein the creating the preference function and the storing the created preference function in the memory includes:
if two or more options exist in the service when the service is provided to the user, calculating the preference value for each option based on the bio-signals for each option and the information about the characteristics of use, and storing the calculated preference value for each option in the memory.

22. The method of claim 21, further comprising:
at a time of providing the user with the service including the two or more options, through the service terminal, comparing the preference values for respective options stored in the memory; and
if, as a result of the comparison, the preference values for respective options are different from each other, selecting and providing an option having a highest preference value.

23. The method of claim 22, further comprising:
if, as a result of the comparison, each of the preference values for respective options is less than a threshold value, arbitrarily selecting and providing any one of the options.

24. The method of claim 22, further comprising:
after the selected option is provided, measuring the user's bio-signals and the information about characteristics of use and calculating a preference value based on the measured bio-signals and information about the characteristics of use; and
updating the memory based on the calculated preference value.
